(19) United States
(12) Patent Application Publication
(10) Pub. No.: US 2007/0165705 A1
(43) Pub. Date: Jul. 19, 2007

(54) METHOD OF ENHANCING FREQUENCY DIVERSITY IN BLOCK CDMA SYSTEMS

(75) Inventor: Justin Coon, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/534,813

(22) Filed: Sep. 25, 2006

(30) Foreign Application Priority Data
Jan. 19, 2006 (GB) 0601103.5

(51) Int. Cl. H04B 1/00

(52) U.S. Cl. 375/148

(57) ABSTRACT

Code division multiple access (CDMA) is a popular multiple access technique that is used to support multiple users simultaneously in a network. Many variants of CDMA exist, including direct sequence (DS) CDMA, multi-carrier (MC) CDMA, cyclic prefixed (CP) CDMA, and chip interleaved block spread (CIBS) CDMA. In addition to these variations, many receiver architectures are often available for implementation in CDMA systems, such as the well-known RAKE receiver, interference cancellation receivers, and receivers that rely on channel equalisation.

Many MUI-free techniques rely on user separation in the frequency domain by assigning mutually exclusive sets of tones to each user. The known techniques of multiple access, however, do not allow each individual user to fully exploit the frequency diversity in the channel since each user only utilises a portion of the total available bandwidth to transmit a message. According to the present invention users can enhance and adaptively exploit the frequency diversity in the channel by simply altering the spreading codes that are used in a block CDMA system. MUI-free transmission is maintained by employing the techniques disclosed here. Furthermore, this technique can easily be extended to multiple-input multiple-output (MIMO) systems.

This invention relates to a method of transmission based on block CDMA. More particularly it relates to a method of enhancing the frequency diversity in the channel in multiple access transmission based on block CDMA. It also relates to a signal generated by the method and a method of receiving such transmission.

Code division multiple access (CDMA) is a popular multiple access technique that is used to support multiple users simultaneously in a network. Many variants of CDMA exist, including direct sequence (DS) CDMA, multi-carrier (MC) CDMA, cyclic prefixed (CP) CDMA, and chip interleaved block spread (CIBS) CDMA. In addition to these variations, many receiver architectures are often available for implementation in CDMA systems, such as the well-known RAKE receiver, interference cancellation receivers, and receivers that rely on channel equalisation.

U.S. 2004/120274, incorporated herein by reference, discloses CDMA transceiver techniques for wireless communications. The method addresses orthogonality between users and symbol detection regardless of the frequency-selective fading channels.

A chip-interleaved, block-spread multi-user communication based on spreading techniques for maintaining the orthogonality of user waveforms in multi-user wireless communications systems, such as CDMA, has been discussed in U.S. 2002/126740, incorporated herein by reference

Zhendao Wang, Giannakis, G. B. have described a systematic discrete-time framework and systems for single- and multiuser wireless multicarrier communications in: “Wireless multicarrier communications”, Signal Processing Magazine, May 2000, Volume 17, Issue 3, pages 29-48, incorporated herein by reference.

Shengli Zhou, Giannakis, G. B., Le Martret, C. in: “Chip-interleaved block-spread code division multiple access”, IEEE Transactions on Communications, February 2002 Volume 50, Issue 2, pages 235-248, incorporated herein by reference, have discussed a multiuser-interference (MUI)-free code division multiple access (CDMA) transceiver for frequency-selective multipath channels is developed. Based on chip-interleaving and zero padded transmissions, orthogonality among different users' spreading codes is maintained at the receiver even after frequency-selective propagation. In addition to MUI-free reception, the system achieves high bandwidth efficiency by increasing the symbol block size.

The performance of single-carrier frequency division multiple access has been discussed in: “Performance comparison of distributed FDMA and localised FDMA with frequency hopping for EUTRA uplink,” NEC Group and NTT DoCoMo, TSG RAN WG1 Meeting 42 R1-050791, August 2005, incorporated herein by reference.

An example of single-carrier frequency division multiple access has been proposed by D. Galda and H. Rohling in: “A low complexity transmitter structure for OFDM-FDMA uplink systems,” in Proceedings of the IEEE Vehicular Technology Conference (VTC), vol. 4, May 2002, pp. 1737-1741, incorporated herein by reference.

A throughput efficient block-spreading CDMA has been proposed by S. Tomasin and F. Tosato, in: “Throughput Efficient Block-Spreading CDMA: Sequence Design and Performance Comparison,” Proceedings of the IEEE Global Telecommunications Conference (Globecom), November-December 2005, incorporated herein by reference.

A discussion of conventional single-carrier frequency division multiple access can be found in: “Carrier synchronization requirements for CDMA systems with frequency-domain orthogonal signature sequences” Dinis, R., Chan Tong Lam, Falconer, D. D., 2004 IEEE Eighth International Symposium on Spread Spectrum Techniques and Applications, 30 Aug.-2 Sep. 2004, pages 821-825, incorporated herein by reference.

Some CDMA schemes are interference limited; that is to say, as the number of users in the network increases, residual interference caused by each user eventually cripples the network, thus rendering simultaneous multiple access nearly impossible. This residual interference generally results from the loss of orthogonality amongst users, which primarily occurs when the channel is temporally dispersive. Several recent developments in block CDMA systems, such as so-called ‘generalised MC-CDMA’ (GMC-CDMA) [Zhendao Wang, et al. (supra)], CIBS-CDMA [Shengli Zhou, et al. (supra)], single-carrier frequency division multiple access (SC-FDMA) (DFT-spread OFDM) [NEC Group et al. (supra); D. Galda et al. (supra)], and the throughput-efficient block CDMA system proposed in S. Tomasin et al. (supra) have led to multi-user interference (MUI) free transmission techniques. In these systems, any number of users—up to a given maximum number—can theoretically transmit simultaneously without causing any degradation in system performance. Beyond this maximum number of allowable users, the system becomes interference limited in a similar manner to other CDMA systems.

Many of the aforementioned techniques rely on transmitting signals from different users on mutually exclusive portions of the total available bandwidth to mitigate MUI. For example, in GMC-CDMA and SC-FDMA, each user is assigned a specific set of frequency tones on which that user transmits data, and all sets of tones are mutually exclusive so that users' transmissions do not interfere with one another. Typically, each set of tones is designed such that a user's transmission is spread across the bandwidth as shown in FIG. 1, so that tones that are adjacent to one another in the set of all tones do not necessarily belong to the same user. This interleaving of tones helps to ensure that, along with the use of a channel code or data spreading, each transmission is able to exploit the frequency diversity in the channel.

When users' transmissions take the form that is illustrated by FIG. 1, the full frequency diversity in the channel is not exploited. This results from the fact that a user's transmission is confined to only a portion of the total available bandwidth. In the limit, when a network is fully loaded, each user may only have one tone over which that user can transmit information. In this example, it is easy to see that unless steps are taken to utilise more of the bandwidth than the one tone, a user's transmission could be completely lost if the channel frequency response on that tone is particularly bad (i.e. there is a deep fade in the user's frequency bin).

In conventional SC-FDMA or GMC-CDMA systems, frequency diversity is enhanced by applying a different progressive phase rotation on each transmitted block in the case of the former technique [Dinis, R., et al. (supra)], or by manually assigning different subcarriers to each user in the case of the latter technique [Zhendao Wang, et al. (supra)].

An additional problem encountered in practice occurs when a transmitted packet is very short (i.e. on the order of only a few blocks of data symbols). An example of this scenario is the header of a packet in, say, a multi-band OFDM system. In this case, the header is encoded with a channel code separately (i.e. separated from the payload) and resides e.g. in only twelve blocks as proposed by Batra, A. et al., in “MultiBand OFDM Physical Layer Proposal for IEEE 802.15 Task Group 3a”, MBOA-SIG, 14 Sep. 2004, incorporated herein by reference. When presented with this scenario, conventional GMC-CDMA and SC-FDMA systems cannot fully exploit the frequency diversity in the channel because there are not enough blocks available to cycle the transmission through the entire bandwidth.

Accordingly, aspects of the present invention seek to mitigate, alleviate or eliminate the above mentioned problems.

The present invention addresses the above mentioned problems in block CDMA systems by altering the spreading codes to change the set of frequency tones over which data is transmitted. The MUI-free property of block CDMA is dependent only upon the spreading codes. According to the present invention, even when transmitting very short packets, by using specially designed spreading codes each user's transmission can be spread across the entire bandwidth while maintaining MUI-free transmission.

In a first aspect of the present invention, a method of enhancing the frequency diversity in the channel in multiple access transmission based on block CDMA for any number of users whose data to be transmitted is separated into a number of blocks comprises spreading each block using any one of a plurality of predetermined spreading codes prior to transmission.

In one configuration of the above aspect, the plurality of predetermined spreading codes comprises DFT spreading codes.

In another configuration of the above aspect, the spreading code is selected in a pseudorandom fashion from the plurality of predetermined spreading codes.

In a further configuration of the above aspect, the order in which the spreading codes are used is such that the frequency diversity is enhanced for a given number of blocks.

In another configuration of the above aspect, the selection of the spreading codes follows a cyclic fashion and comprises selecting a first spreading code for the first block to be transmitted from the plurality of predetermined spreading codes in a random manner; and selecting each subsequent spreading code for each subsequent block to be transmitted among those of the plurality of predetermined spreading codes not previously used during the present cycle, according to the highest frequency shift induced.

In a further configuration of the above aspect, the method further comprises employing a channel code or error correction code to enhance the frequency diversity in the channel.

In another configuration of the above aspect, the spreading code for a given user can be temporarily altered so as to transmit over the full bandwidth and thus maximally exploit the frequency diversity in the channel for a given period of time.

In a further configuration of the above aspect, a plurality of transmit antennas are employed.

Another aspect of the present invention, comprises a signal in multiple access transmission based on block CDMA, as generated by a method of any one of the preceding claims.

In another aspect of the present invention, a method of receiving a signal in multiple access transmission based on block CDMA enhancing the frequency diversity in the channel for any number of users whose transmitted data is separated into a number of blocks comprises de-spreading each received block using each one of a plurality of predetermined de-spreading codes.

In one configuration of the above aspect, the plurality of predetermined spreading codes comprises DFT de-spreading codes.

In another configuration of the above aspect, the de-spreading code is selected in a pseudorandom fashion from the plurality of predetermined de-spreading codes.

In a further configuration of the above aspect, the order in which the de-spreading codes are used is such that the frequency diversity is enhanced for a given number of blocks.

In another configuration of the above aspect, the selection of the de-spreading codes follows a cyclic fashion and comprises selecting a first de-spreading code for the first block to be transmitted from the plurality of predetermined de-spreading codes in a random manner; and selecting each subsequent de-spreading code for each subsequent block to be transmitted among those of the plurality of predetermined spreading codes not previously used during the present cycle, according to the highest frequency shift induced.

In a further configuration of the above aspect, the method comprises employing a channel code or error correction code in decoding the user's signal.

In another configuration of the above aspect, the de-spreading code for a given user can be temporarily altered so as to receive over the full bandwidth for a given period of time.

In a further configuration of the above aspect, a plurality of receive antennas is employed.

These and other aspects of the invention will now be further described, by way of example only, with reference to the accompanying figures in which:

FIG. 1 illustrates one user's set of frequency tones in a GMC-CDMA or an SC-FDMA system.

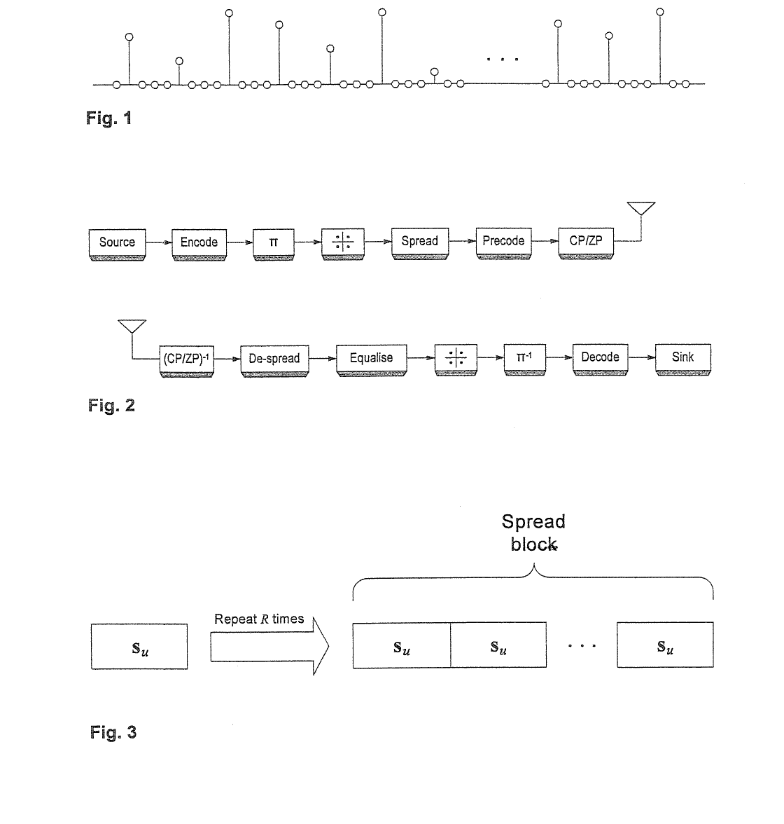

FIG. 2 depicts a block diagram of a transmitter/receiver structure of block CDMA.

FIG. 3 illustrates the spreading operation.

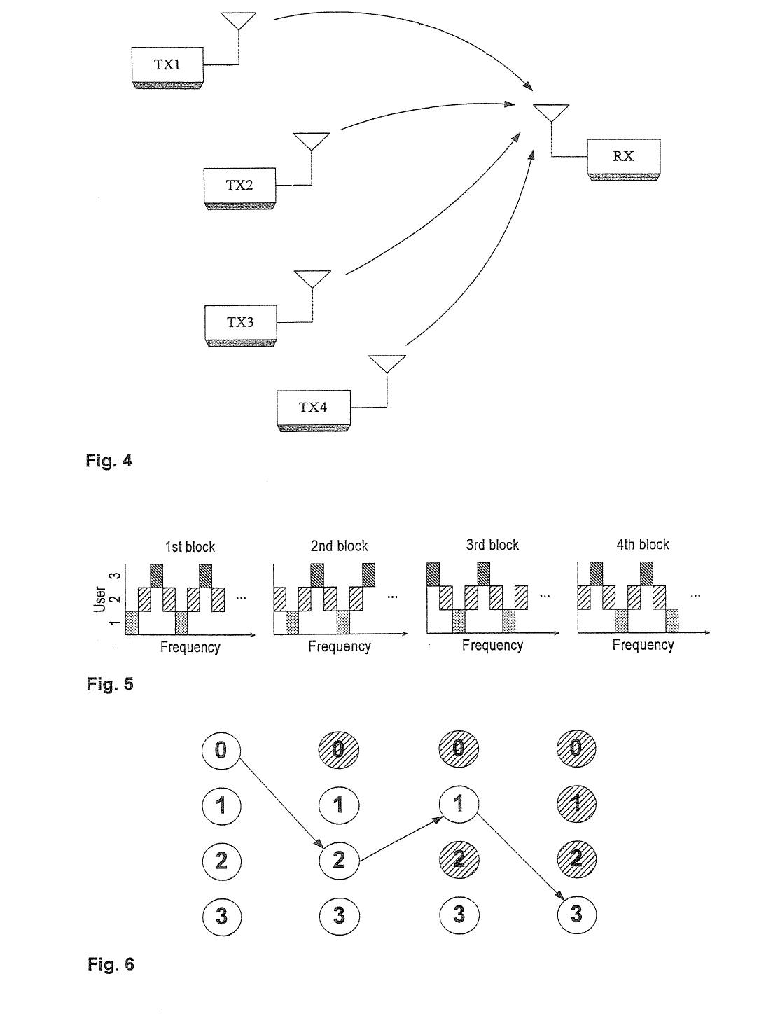

FIG. 4 shows an example of users' signals interfering with each other in the channel and combining at the receiver.

FIG. 5 illustrates the bandwidth utilisation when DFT codes are used as spreading codes and each user cycles through the codes with each transmitted block.

FIG. 6 illustrates an example of maximally exploiting frequency diversity through cycling of spreading codes (R=4).

FIG. 7 illustrates the frequency diversity exploitation for DFT spreading codes and self-shift-orthogonal spreading codes.

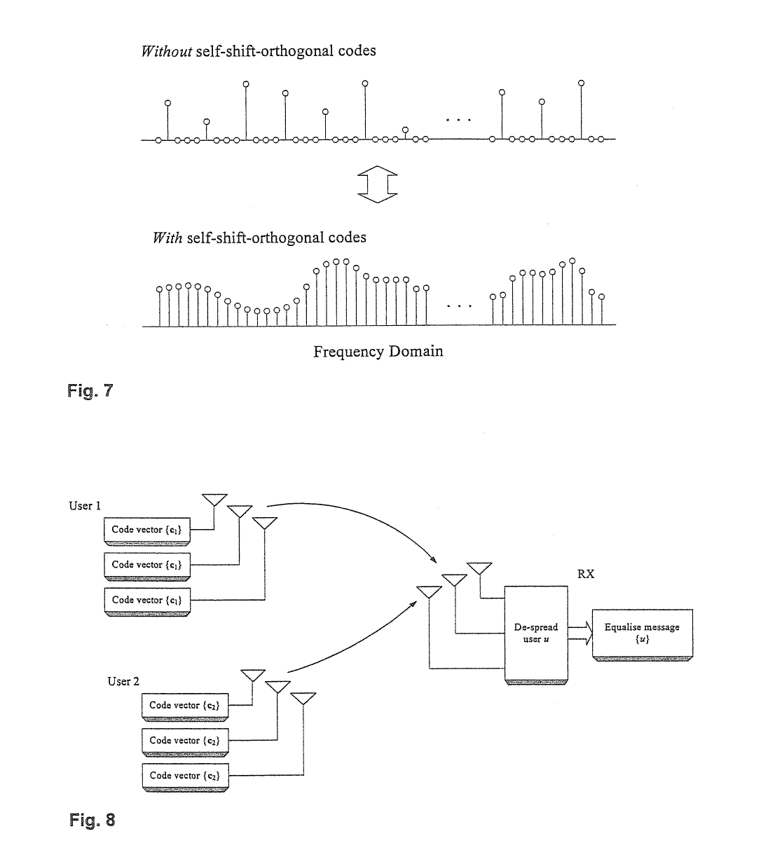

FIG. 8 illustrates user separation and subsequent MIMO detection.

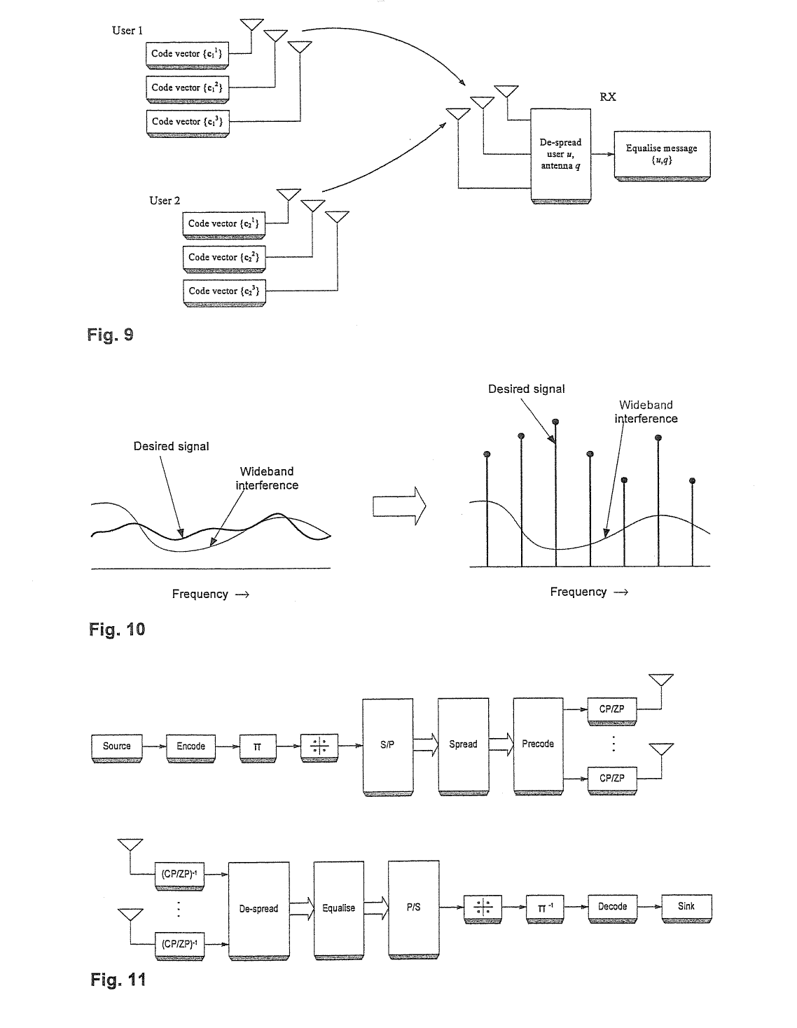

FIG. 9 illustrates joint user and multiple stream separation.

FIG. 10 illustrates the SINR improvement that occurs when DFT spreading codes are used adaptively.

FIG. 11 depicts a block diagram of a MIMO system that incorporates the invention.

A method of increasing the frequency diversity in the channel in multiple access transmission based on block CDMA is disclosed. The invention also relates to a signal generated by the method. Also disclosed is a method of receiving a signal increasing the frequency diversity in the channel in multiple access transmission based on block CDMA. In the following description a number of specific details are presented in order to provide a thorough understanding of embodiments of the present invention. It will be apparent, however, to a skilled person in the art that these specific details need not be employed to practice the present invention.

The present invention proposes a method of signal processing whereby a block CDMA transmission is adaptively configured in such a way as to enhance the frequency diversity in the channel. The proposed invention expands on the block CDMA technique proposed in co-pending UK patent application No. GB 0525641.7 (Toshiba) incorporated herein by reference in its entirety, which has a general transmitter/receiver structure as illustrated in FIG. 2. The key elements of this structure are the spreading/de-spreading blocks and the precoding block. The equaliser block can, in general, represent any single-user, linear or nonlinear, time-domain or frequency-domain equaliser (i.e. linear zero forcing (ZF), linear minimum mean-squared error (MMSE), decision feedback equaliser (DFE), etc.). It is important to review the structure of block CDMA for the purpose of detailing the invention proposed in this document.

Considering the transmitter of Block CDMA first, and referring again to FIG. 2, the transmitted message is constructed in the form of a stream of bits that are encoded, interleaved, and mapped to complex baseband symbols that are members of a given constellation, such as M-PSK (Phase Shift Keying) or M-QAM (Quadrature Amplitude Modulation). The resulting complex constellation symbols are arranged into groups of N symbols.

Let the vector sᵤ(i) denote the uth user's length-N symbol (column) vector at time i. The spreading operation shown in FIG. 2 performs a simple R-fold repetition on the vector sᵤ(i), which can be mathematically defined as

tᵤ(i)=(1_{R} [symbol] I_{N})sᵤ(i)

where 1_{R} is the length-R column vector of ones, I_{N} is the N×N identity matrix, and \textcircled{x} is the Kronecker product operator. This repetition is illustrated in FIG. 3.

Following the spreading operation, a preceding operation is applied to the data vector. This precoder is linear; thus the preceded signal can be represented as

xᵤ(i)=θᵤ(i)tᵤ(i)

where θᵤ(i) is the uth user's P′×P (possibly redundant) preceding matrix for the ith block. Note that P=RN, P′=RN′, N′≧N and P′≧P. If L is the memory order of the channel impulse response, it is important that N′≧L+1 holds true in order to perform low-complexity de-spreading and detection at the receiver. Following the precoding operation, a cyclic extension is appended to the user's message. This extension takes the form of a cyclic prefix (CP) or zero padding (ZP). It is assumed that the CP/ZP consists of Q≧L symbols so that inter-block interference is mitigated. It is further assumed that the channel remains static for the duration of each individual block.

The receiver of block CDMA is characterised as follows. Assuming simultaneous synchronous transmission, the signals from all U users interfere with each other in the channel and are subsequently combined at the receiver as shown in FIG. 4. Thus, the signal at the receiver, after removal of the CP/ZP, can be represented by

$$\begin{matrix}r ( i ) = {\sum }_{u = 1}^{U} {H}_{u} ( i ) {x}_{u} ( i ) + v ( i ) \\ = {\sum }_{u = 1}^{U} {H}_{u} ( i ) {θ}_{u} ( i ) ( {1}_{R} ⊗ {I}_{N} ) {s}_{u} ( i ) + v ( i )\end{matrix}$$

where Hᵤ(i) is a P′×P′ circulant channel matrix describing the impulse response of the channel between the uth user and the receiver at time i and v(i) is a length-P′ vector of zero-mean white Gaussian noise samples, each with a variance of σ²/2 per dimension.

The received vector r(i) is passed through a de-spreader to separate the desired user's signal from all other users' signals, which gives

yᵤ(i)=Ψᵤ^{H}(i)r(i)

where Ψᵤ(i) is the uth user's P′×N de-spreading matrix. Consequently, the preceding and de-spreading matrices should be designed such that

yᵤ(i)=Ψᵤ^{H}(i)Hᵤ(i)θᵤ(i)(1_{R} [symbol] I_{N})sᵤ(i)+Ψᵤ^{H}(i)v(i)

for all u. Furthermore, it is desirable from a detection point of view that the modified noise Ψᵤ^{H}(i)v(i) remains white. This design criterion can be summarised as follows.

Criterion. For MUI-free communication, the precoding and de-spreading matrices should be designed such that

G(u,u′,i)=Ψ_{u′}^{H}(i)Hᵤ(i)θᵤ(i)(1_{R} [symbol] I_{N})=0_{N},
∀i,u,u′ such that u≠u′and

Ψᵤ^{H}(i)Ψᵤ(i)=cI_{N}, ∀i,u

where 0_{N} is the N×N matrix of zeros and c is a constant.

Finally, the length-N de-spread symbol vector yᵤ(i) is passed through an equaliser to recover an estimate of the transmitted data. It is important to note that the de-spread symbol vector yᵤ(i) ideally does not contain interference from other users. Consequently, any conventional single-user linear or non-linear equaliser can be applied to the de-spread signal.

The following considerations apply for designing the precoding and de-spreading matrices. It can be shown that the circulant channel matrix Hᵤ can be expressed as

Hᵤ=I_{R} [symbol] H_{u,0}+J_{R} [symbol] H_{u,1}

where J_{R} is just I_{R} circularly shifted downward along its columns by one element, and H_{u,0} and H_{u,1} are lower and upper N′×N′ Toeplitz matrices that define the channel impulse response. The time index i has been omitted here for brevity. With this representation of the channel matrix, it is intuitive to define the uth user's preceding matrix as follows:

θᵤ=Cᵤ [symbol] Λᵤ

where Cᵤ is an R×R diagonal spreading code matrix and Λᵤ is an N′×N sub-block preceding matrix. Similarly, the uth user's de-spreading matrix should be designed as follows:

Ψᵤ=dᵤ [symbol] Γᵤ

where dᵤ is an R×1 de-spreading vector and Γᵤ is an N′×N sub-block decoding matrix. With these definitions, G(u,u′) can be written as

G(u,u′)=d_{u′}^{H}Cᵤ1_{R} [symbol] Γ_{u′}^{H}H_{u,0}Λᵤ+d_{u′}^{H}J_{R}Cᵤ1_{R} [symbol] Γ_{u′}^{H}H_{u,1}Λᵤ

which shows that users can be perfectly separated at the receiver through careful design of the spreading codes (i.e. the elements on the diagonal of Cᵤ) and the de-spreading vectors dᵤ.

In the following, cycling the spreading codes from block to block will be discussed. The present invention mainly deals with the design of the spreading codes cᵤ=Cᵤ1_{R}. The expression for G(u,u′) given above suggests that in order for users to be perfectly separable at the receiver, the spreading codes for all users must be orthogonal (i.e. d_{u′}^{H}cᵤ=0 for all u≠u′) and mutually shift-orthogonal (i.e. d_{u′}^{H}J_{R}cᵤ=0 for all u≠u′). Spreading codes that satisfy these criteria include the columns of an R×R DFT matrix (easily verified). However, when these codes are used, each user's transmission is assigned to only a subset of all of the available tones. Also, the tones in this subset are equally spaced at every Rth tone as depicted in FIG. 1 where R=4. The exact subset of tones (i.e. the frequency shift) is defined by the spreading code that is used.

In one aspect of this invention, depicted in FIG. 5, the spreading code and corresponding de-spreading code are cycled through the R available codes at regular intervals of transmitted blocks. For example, perhaps the same spreading code is used for two blocks, then the code is changed and the new code is used for the next block, after which the code is changed again and the new code is used for the following five blocks. Of course, it makes sense to cycle through the R spreading codes with every block, which might produce an effect on the users' transmissions as shown in FIG. 5.

Usually, the exact order in which the codes are used by the transmitter will be unknown at the receiver. Since each block contains a header comprising, among other data, also information on the user, this user information can be employed at the receiver to re-attribute the blocks received via different spreading codes to each user.

It is worth noting that the exact order in which the codes are used may be pseudorandom, in which case this pattern would be known at both the transmitter and the receiver. An example of code cycling over six blocks for the case where R=4 is given below.

Example: Suppose the available spreading codes are denoted by the length-R column vectors f₀, f₁, f₂, and f₃. User u may decide to apply the third code to the first transmitted block, which would give cᵤ(0)=dᵤ(0)=f₂. The first code may be applied to the second and third blocks. The second code could be applied to the fourth and fifth blocks, and the fourth code might be applied to the sixth block. The codes are thus defined as:
cᵤ(0)=dᵤ(0)=f₂
cᵤ(1)=dᵤ(1)=f₀
cᵤ(2)=dᵤ(2)=f₀
cᵤ(3)=dᵤ(3)=f₁
cᵤ(4)=dᵤ(4)=f₁
cᵤ(5)=dᵤ(5)=f₃

It is important to note that any sub-block precoders and decoders can be used along with this method of code cycling without jeopardising the MUI-free property of the system.

The present invention allows enhancing the use of frequency diversity through code cycling. Although code cycling can be performed in a pseudorandom fashion, it is beneficial to cycle through the spreading codes in such as way as to increase the frequency diversity that is used. This is done by considering the spreading code that is used for the first block, then choosing the spreading code that induces the greatest frequency shift in the transmitted signal for the next block. For the next block transmission, the codes that were used with the first two blocks are considered and the next code is chosen such that the frequency tones that are used are maximally distant from the first two codes. This process is repeated for all subsequent blocks where all previously used codes are considered but not used for each subsequent block until all codes have been exhausted, at which point the cycling begins again.

An example of this technique is depicted in FIG. 6, which illustrates an aspect of maximally exploiting frequency diversity through cycling of spreading codes (R=4). The numbers in the circles represent the frequency offset; the white circles represent codes that haven't been chosen yet and the grey circles represent codes that have been chosen and cannot be chosen again until all codes have been used. Note that the frequency offset wraps around (e.g. a frequency offset of 3 is identical to −1, which is why 2 is chosen instead of 3 for the first code change).

When transmitting short packets, it is important to increase the use of frequency diversity. If the number of blocks in a packet is M, the spreading factor is R (i.e. there are R different spreading codes), and M<<R, then not all codes can be cycled through to maximally exploit frequency diversity. In this case, self-shift-orthogonal codes can be employed for the short packet; so dᵤ^{H}J_{R}Cᵤ1_{R}=0 for all u. The advantage of taking this approach is that the resulting received, de-spread signal resembles a conventional single-carrier transmission that has passed through a linear time-invariant channel (rather than a circulant channel as has been the case up until now). Techniques such as successive interference cancellation and other conventional time-domain equalisers can be employed with ease given this scenario. Also, the transmitted signal in this case spans the entire bandwidth; thus, the frequency diversity in the channel is maximally exploited. This result is illustrated in FIG. 7. An example of sequences with these orthogonality properties is given below:

$${c}_{1} = ( \begin{matrix}1 \\ - 1 \\ - 1 \\ - 1\end{matrix} ) , {c}_{2} = ( \begin{matrix}- 1 \\ - 1 \\ 1 \\ - 1\end{matrix} ) .$$

The codes given in this example can support two users simultaneously. It is important to note that the extra degree of freedom that is required to impose the self-shift-orthogonality condition on the sequences causes a reduction in the number of users that can be supported simultaneously in a network (by half). Thus, once the short packet has been transmitted, each user should switch back to using more efficient spreading codes, such as DFT codes.

A general set of spreading codes that are orthogonal, mutually shift-orthogonal, and self-shift-orthogonal are Chu sequences. The nth element of a length-R Chu sequence (column vector) a_{l,R} is defined by

$${a}_{l , R} ( n ) = \{ \begin{matrix}{e}^{jπ {n}^{2} l / R} , & for even R \\ {e}^{jπ n ( n + 1 ) l / R} , & for odd R\end{matrix}$$

where l and R are relatively prime. Now define the mth cyclic shift matrix as the mth power of J_{R}:

C_{R}^{(m)}:=J_{R}^{m}

where J_{R}⁰=I_{R}. With this definition, it can easily be verified that a set of length-R codes that satisfy all three orthogonality conditions is given by

$${Ω}_{l , R} = \{ {a}_{l , R} , {J}_{R}^{2} {a}_{l , R} , {J}_{R}^{4} {a}_{l , R} , … , {J}_{R}^{2 ( ⌊ \frac{R}{2} ⌋ - 1 )} {a}_{l , R} \}$$

for any l and R where the notation └·┘ denotes the integer part of the argument. This result follows from the nice property that all Chu sequences have perfect periodic autocorrelation properties (i.e. the correlation of a Chu sequence with its circularly shifted version is zero).

As shown in FIG. 8, the present invention may be used with multiple transmit and/or receive antennas. When multiple transmit antennas are employed, the techniques described above can be applied at each of the antennas. In particular, different spreading codes can be applied to any subset of the messages at the different transmit antennas for a single user. For example, the same spreading code can be applied to the messages at all transmit antennas, in which case the receiver can de-spread the received signal to recover the desired user's multi-antenna transmission. This case is illustrated in FIG. 8 where it is observed that the well-studied multiple-input multiple-output (MIMO) detection problem remains after the de-spreading process is complete.

Alternatively, as shown in FIG. 9, a different spreading code can be applied at each transmit antenna for a single user. In this case, the receiver is able to separate all users as well as a single user's messages that were transmitted from the various transmit antennas as shown in FIG. 9. If multiple receive antennas are employed, the received message is de-spread for each receive antenna prior to further processing such as MIMO detection.

As previously mentioned, conventional systems must either utilise phase rotations of the transmitted signal (in the case of SC-FDMA [Dinis, R., et al. (supra)]) or manually assign sets of subcarriers to users (GMC-CDMA [Zhendao Wang, et al. (supra)]).

The method according to the present invention only relies on the alteration of spreading codes to change the set of frequency tones over which data is transmitted. This allows the system to be highly and easily configurable. For example, if other spreading codes are used, such as self-shift-orthogonal codes, the spectrum of the transmitted signal can be changed very easily to comply with the prevailing transmission environment. When a packet is very short, this configurability is very useful, and cannot in general be achieved with conventional systems.

Referring now to FIG. 10, the proposed configurability method can also be exploited in a manner that is opposite to the techniques presented above. In particular, a transmission that fully exploits frequency diversity (e.g. a self-shift-orthogonal transmission) can be adaptively configured to only use a portion of the total available bandwidth. This approach can be used for spectrum shaping or interference (narrowband and wideband) mitigation/avoidance. For example, suppose an interfering signal occupies the entire transmission bandwidth and the desired signal also utilises the full bandwidth. In this case, the desired signal can be adaptively made to use DFT spreading codes. Through conservation of energy, the total transmit power does not change through this adaptation; instead, the power of the desired signal is localised to a subset of frequency tones. The signal-to-interference-plus-noise ratio (SINR) on these tones is thus increased as illustrated in FIG. 10, which results in a better overall performance. Similarly, one or more narrowband interferers may be completely avoided by switching to DFT spreading codes.

A typical block diagram of a MIMO system incorporating the invention is illustrated for convenience in FIG. 11. Data coming from the source is encoded before it is interleaved and subsequently mapped. Alternatively, one or both of the encoding and interleaving steps may be omitted. The serial data stream is then converted into a number of parallel data streams. The key elements of this structure are again the spreading/de-spreading blocks and the preceding block through which the now parallel streams are passed. Before transmitting, a guard interval is applied to each stream in the form of a cyclic prefix (CP) or zero padding (ZP) to separate different spread blocks.

Also shown in FIG. 11, the receiver removes the guard interval of each stream before de-spreading the received parallel signals. As described earlier, the equaliser block can, in general, represent any single-user, linear or nonlinear, time-domain or frequency-domain equaliser (i.e. linear zero forcing (ZF), linear minimum mean-squared error (MMSE), decision feedback equaliser (DFE), etc.). The parallel streams are then converted into a serial data stream. De-mapped and de-interleaved, the signal is decoded for outputting to a data sink. Alternatively, one or both of the interleaving or decoding steps may be omitted.

No doubt many other effective alternatives will occur to the skilled person. It will be understood that the invention is not limited to the described embodiments and encompasses modifications apparent to those skilled in the art lying within the spirit and scope of the claims appended hereto.

1. A method of enhancing the frequency diversity in the channel in multiple access transmission based on block CDMA for any number of users whose data to be transmitted is separated into a number of blocks,
wherein each block is spread using any one of a plurality of predetermined spreading codes prior to transmission.

2. The method of claim 1, wherein the plurality of predetermined spreading codes comprises DFT spreading codes.

3. The method of claim 1, wherein the spreading code is selected in a pseudorandom fashion from the plurality of predetermined spreading codes.

4. The method of claim 1, wherein the order in which the spreading codes are used is such that the frequency diversity is enhanced for a given number of blocks.

5. The method of claim 4, wherein the selection of the spreading codes follows a cyclic fashion and comprises:
selecting a first spreading code for the first block to be transmitted from the plurality of predetermined spreading codes in a random manner; and
selecting each subsequent spreading code for each subsequent block to be transmitted among those of the plurality of predetermined spreading codes not previously used during the present cycle, according to the highest frequency shift induced.

6. The method of claim 1, further comprising
employing a channel code or error correction code to enhance the frequency diversity in the channel.

7. The method of claim 1, wherein the spreading code for a given user can be temporarily altered so as to transmit over the full bandwidth and thus maximally exploit the frequency diversity in the channel for a given period of time.

8. The method of claim 1, wherein a plurality of transmit antennas are employed.

9. A signal in multiple access transmission based on block CDMA, as generated by a method of any one of the preceding claims.

10. A method of receiving a signal in multiple access transmission based on block CDMA enhancing the frequency diversity in the channel for any number of users whose transmitted data is separated into a number of blocks,
wherein each received block is de-spread using each one of a plurality of predetermined de-spreading codes.

11. The method of claim 10, wherein the plurality of predetermined spreading codes comprises DFT de-spreading codes.

12. The method of claim 10, wherein the de-spreading code is selected in a pseudorandom fashion from the plurality of predetermined de-spreading codes.

13. The method of claim 10, wherein the order in which the de-spreading codes are used is such that the frequency diversity is enhanced for a given number of blocks.

14. The method of claim 13, wherein the selection of the de-spreading codes follows a cyclic fashion and comprises:
selecting a first de-spreading code for the first block to be transmitted from the plurality of predetermined de-spreading codes in a random manner; and
selecting each subsequent de-spreading code for each subsequent block to be transmitted among those of the plurality of predetermined spreading codes not previously used during the present cycle, according to the highest frequency shift induced.

15. The method of claim 10, further comprising
employing a channel code or error correction code in decoding the user's signal.

16. The method of claim 10, wherein the de-spreading code for a given user can be temporarily altered so as to receive over the full bandwidth for a given period of time.

17. The method of claim 10, wherein a plurality of receive antennas is employed.
